(19) United States
(12) Patent Application Publication
(10) Pub. No.: US 2009/0261545 A1
(43) Pub. Date: Oct. 22, 2009

(54) SECURITY DEVICE

(76) Inventor: A. VERN JONES, Bakersfield, CA (US)

Correspondence Address: James Ray & Associates, 2640 Pitcairn Road, Monroeville, PA, 15146, US

(21) Appl. No.: 12/412,420

(22) Filed: Mar. 27, 2009

Related U.S. Application Data
(60) Provisional application No. 61/045,376, filed on Apr. 16, 2008.

(51) Int. Cl. B62B 3/14

(52) U.S. Cl. 280/33.994

(57) ABSTRACT

A security device for attachment to a shopping cart includes a generally hollow cage member manufactured from a predetermined material and having a predetermined size and a predetermined shape for enclosing at least one predetermined item therein. A first access mechanism is engaged with such cage member for enabling a user to selectively access an interior portion of such cage member. A securing mechanism is disposed on such cage member and engage able with such shopping cart for releasably attaching such cage member to such shopping cart at a predetermined location at least one of on such shopping cart, within such shopping cart, and a combination thereof.

### CROSS REFERENCE TO RELATED APPLICATION

This patent application is related to and claims priority from U.S. Provisional Patent Application Ser. No. 61/045,376 filed Apr. 16, 2008.

### FIELD OF THE INVENTION

The present invention relates, in general, to security devices and, more particularly, this invention relates to a security device for use with a shopping cart, such security device for releasably housing valuables such as a purse and the like.

### BACKGROUND OF THE INVENTION

Prior to the conception and development of the present invention, shopping carts, as are generally well known in the prior art, have been used by shoppers to collect items that such shoppers intend to purchase. Shopper's routinely place valuable items, such as purses and wallets, in such shopping carts. Unfortunately as a shopper becomes distracted or busy theft of such valuables may occur.

Specifically of interest to the present invention are the following: Harris, U.S. Pat. No. 5,542,687, discloses a panel adapted to engage the supporting frame of an infant seat support in a shopping cart and to pivot downwardly through the bottom of the merchandise compartment of the cart to form a triangular enclosure in the cart.

Soriano, U.S. Pat. No. 4,361,340, discloses a modification of a grocery cart including an enclosed compartment under the grocery cart child seat for the temporary containment of valuables such as purses. Soriano also discloses a retrofit device for use with waist level type shopping carts.

Myers, U.S. Pat. No. 5,002,292, discloses a security device for use in shopping carts including at least two elongated panels arranged for mutual contact between the basket side walls to form an enclosure wherein at least one of the panels contains a hinged edge allowing pivotal movement of the panel for access to the enclosure.

Kraper, U.S. Pat. No. 5,004,252, discloses a shopping basket accessory including a partition for covering a bin area of a conventional shopping cart and for providing a solid writing surface proximate the handle on the conventional shopping cart.

### SUMMARY OF THE INVENTION

The present invention provides a security device for attachment to a shopping cart. Such security device includes a generally hollow cage member manufactured from a predetermined material and having a predetermined size and a predetermined shape for enclosing at least one predetermined item therein. A first access means is engaged with such cage member for enabling a user to selectively access an interior portion of such cage member. A securing means is disposed on such cage member and engageable with such shopping cart for releasably attaching such cage member to such shopping cart at a predetermined location at least one of on such shopping cart, within such shopping cart, and a combination thereof.

According to another embodiment, in combination with a shopping cart, an improvement is provided. Such improvement includes a security device attached to such shopping cart. Such security device includes a generally hollow cage member manufactured from a predetermined material and having a predetermined size and a predetermined shape for enclosing at least one predetermined item therein. An access means is engaged with such cage member for enabling a user to selectively access an interior portion of such cage member.

### OBJECTS OF THE INVENTION

It is, therefore, one of the primary objects of the present invention to provide a security device for enclosing a purse or other valuable items there in, such security device being attachable to a shopping cart such that such shopping cart may nest with other shopping carts.

Another object of the present invention is to provide a shopping cart attachment which can be releasably attached to a shopping cart and which may be used for housing valuables therein to prevent such valuables from being stolen.

Still another object of the present invention is to provide a shopping cart having a collapsible security cage attached thereto, such security cage collapsing when such shopping cart is moved to a nested position within at least one additional shopping cart.

An additional object of the present invention is to provide, in combination with a shopping cart, the improvement of a security device for housing predetermined valuables releasably therein, such security device including a cage-like frame with a lock for locking such valuables such as purses within such cage-like frame, and such cage-like frame further including a small opening disposed there through for enabling a user to extricate predetermined smaller items such as car keys, a cell phone, a grocery list, a baby bottle and the like there from while the remaining items (i.e. the purse, etc.) remain safely therein.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention in which the invention has been attached to a shopping cart near the handle of such shopping cart.

FIG. 3 is a partial perspective view of the invention according to one embodiment of the invention in which the invention is attached to a shopping cart and the invention is shown collapsing such that an additional shopping cart can be nested with such shopping cart to which the invention is attached.

FIG. 4 is a partial perspective view of the invention according to one embodiment of the invention in which the invention has been attached to a lower rear portion of a shopping cart.

FIG. 5 is a partial perspective view of the invention according to one embodiment of the invention.

FIG. 6 is a partial perspective view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

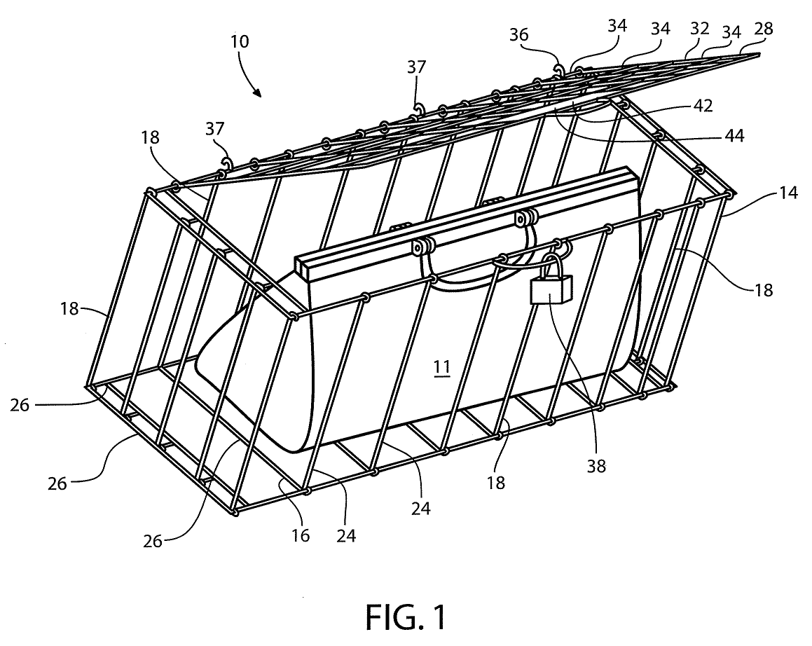

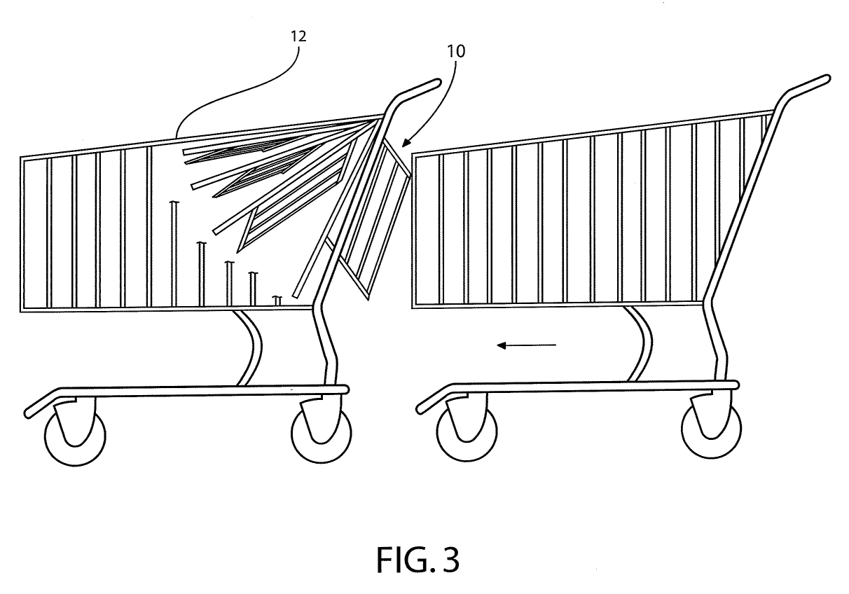

Reference is now made, more particularly, to FIGS. 1-6.

Referring specifically to FIGS. 1-4, the present invention provides a security device, generally designated 10, for attachment to a shopping cart 12.

Such security device 10 includes a generally hollow cage member 14 manufactured from a predetermined material and having a predetermined size and a predetermined shape for enclosing at least one predetermined item 11 therein. It is presently preferred that such cage member 14 is collapsible. It is presently preferred that such predetermined material is at least one of metal, plastic, and a combination thereof. It is presently most preferred that such predetermined material is metal.

It is presently preferred that such cage member 14 includes a bottom 16, two pairs of opposed walls 18 collapsibly connected to such bottom 16 and extending upwardly there from to provide an open top, and wherein such bottom 16 and such walls 18 further include a predetermined arrangement of at least one of a plurality of vertical bars 24, a plurality of horizontal bars 26, and a combination thereof.

A first access means 28 is engaged with such cage member 14 for enabling a user 13 to selectively access an interior portion of such cage member 14. It is presently preferred that such first access means 28 is a door member 32 hingedly connected to such cage member 14. It is presently preferred that such door member 32 is formed from a predetermined arrangement of a plurality of inter-connected bar members 34 extending at least one of laterally, longitudinally, and a combination thereof.

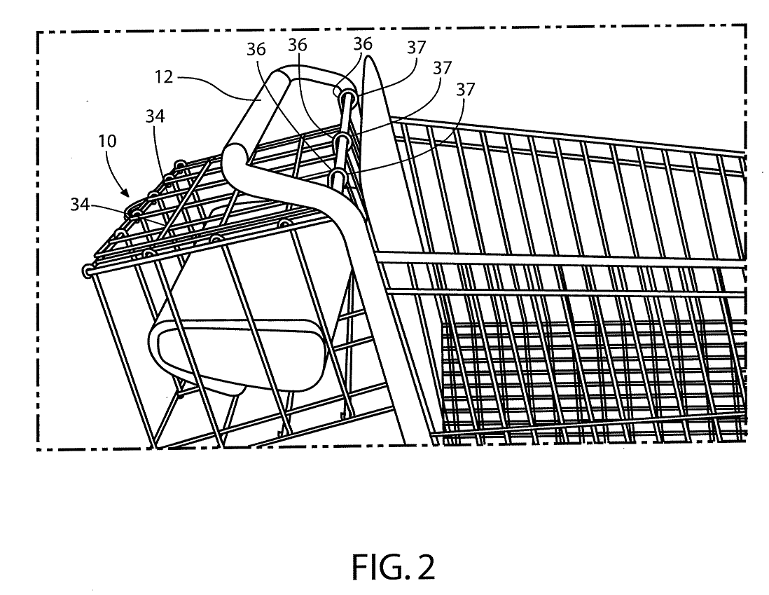

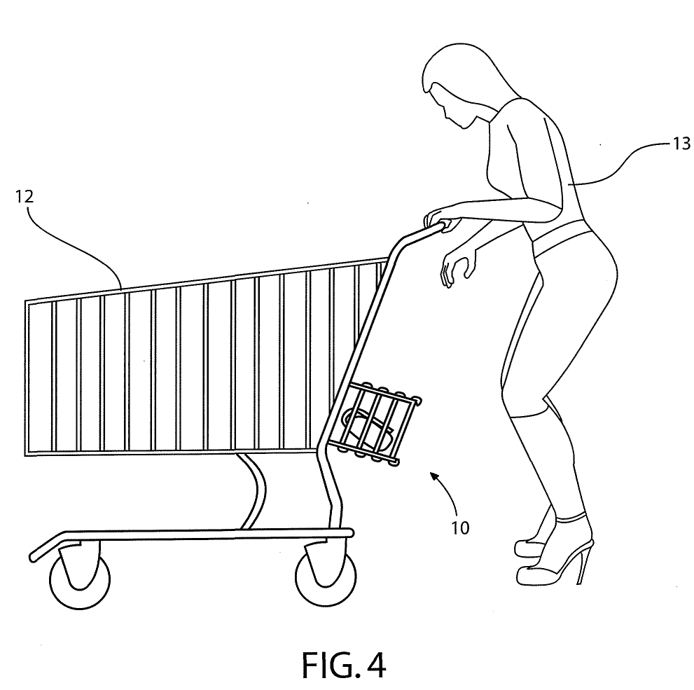

A securing means 36 is disposed on such cage member 14 and engageable with such shopping cart 12 for releasably attaching such cage member 14 to such shopping cart 12 at a predetermined location at least one of on such shopping cart 12, within such shopping cart 12, and a combination thereof. It is presently preferred that such securing means 36 is at least one of at least one hook, at least one clamp, at least one clasp, and a combination thereof. It is presently most preferred that such securing means is at least one hook 37. It is presently preferred that such securing means is a plurality of hooks 37. It is meant that the device be hooked to a shopping cart, such as on an outer rear portion of the shopping cart as shown in FIGS. 2 and 4. However, the device 10 is not meant to be limited as such and may be attached to the front of the shopping cart or to an interior portion of the shopping cart.

It is presently preferred that such security device 10 is at least one of stackable, nestable, and a combination thereof, with at least one of at least one additional security device, at least one shopping cart, and a combination thereof. It is meant that the device may be stacked or nested in a convenient location within or close to a store such that such user may have convenient access to pick up the device 10 and secure it to the shopping cart. Another possibility would be to retrofit the device 10 to a shopping cart and leave it secured thereon, the device collapsing to permit a plurality of such shopping carts each having one of such device attached thereto to be nested together.

It is further presently preferred that such security device 10 further includes a lock member 38 engageable with such cage member 14 and such door member 32 for locking such door member 32 in a closed position.

Additionally, it is presently preferred that such security device 10 further includes a second access means 42 disposed on at least one of such cage member 14 and such door member 32 for enabling such user to access such interior portion of such cage member 14. Preferably such second access means 42 is an aperture 44. It is meant that while such user's valuables are locked within the device 10, such user will still have some access to the valuables. For example, if a purse is enclosed within the cage member but such user's cell phone rings, such user may utilize the aperture 44 to access the purse and obtain the cell phone.

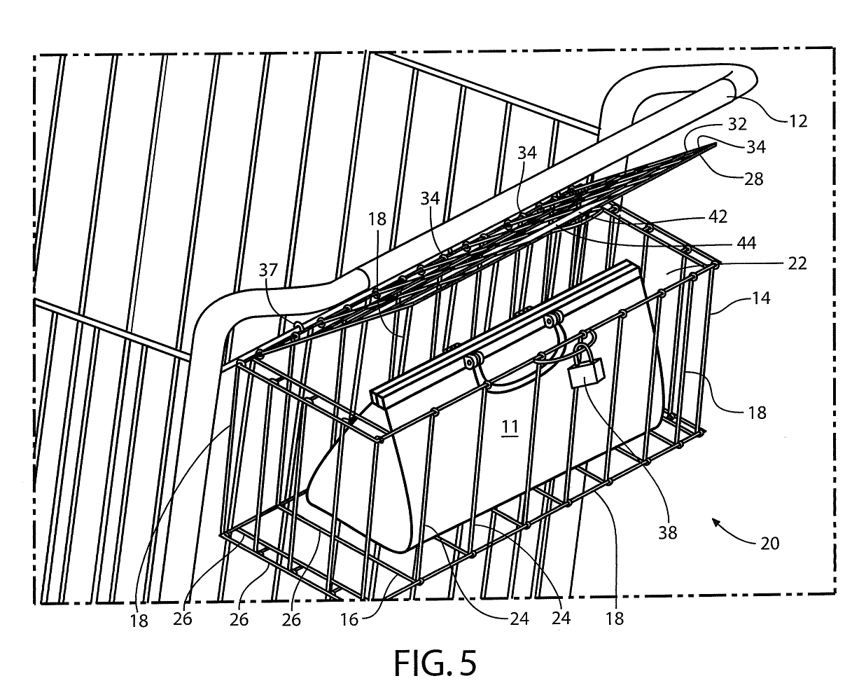

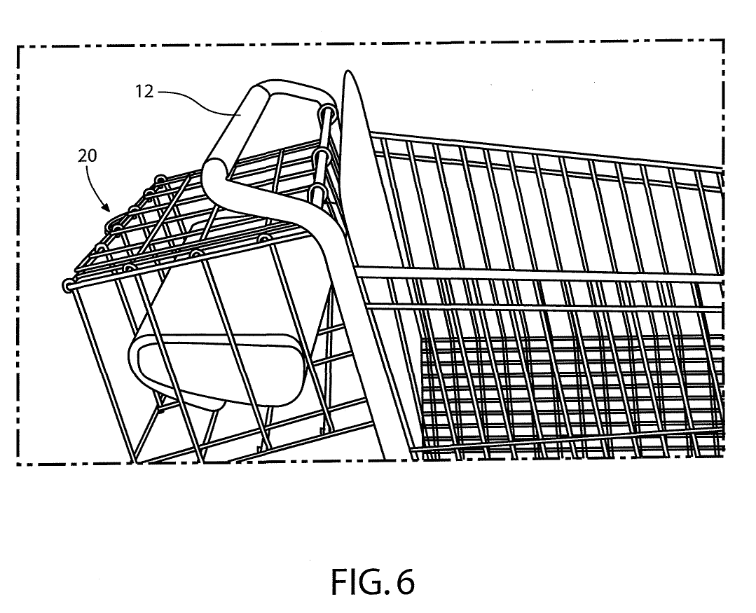

According to another embodiment, referring to FIGS. 5 and 6, in combination with a shopping cart 12, an improvement is provided. Such improvement includes a security device, generally designated 20, attached to such shopping cart 12. Such security device 20 includes a generally hollow cage 14 member manufactured from a predetermined material and having a predetermined size and a predetermined shape for enclosing at least one predetermined item 11 therein. It is presently preferred that such cage member 14 is collapsible. It is presently preferred that such predetermined material is at least one of metal, plastic, and a combination thereof. It is presently most preferred that such predetermined material is metal.

It is presently preferred that such cage member 14 includes a bottom 16, two pairs of opposed walls 18 collapsibly connected to such bottom 16 and extending upwardly there from to provide an open top 22, and wherein such bottom 16 and such walls 18 further include a predetermined arrangement of at least one of a plurality of vertical bars 24, a plurality of horizontal bars 26, and a combination thereof.

A first access means 28 is engaged with such cage member 14 for enabling a user to selectively access an interior portion of such cage member 14. It is presently preferred that such first access means 28 is a door member 32 hingedly connected to such cage member 14. It is presently preferred that such door member 32 is formed from a predetermined arrangement of a plurality of inter-connected bar members 34 extending at least one of laterally, longitudinally, and a combination thereof.

It is further presently preferred that such security device 10 further includes a lock member 38 engageable with such cage member 14 and such door member 32 for locking such door member 32 in a closed position.

Additionally, it is presently preferred that such security device 20 further includes a second access means 42 disposed on at least one of such cage member 12 and such door member 32 for enabling such user to access such interior portion of such cage member 14. Preferably such second access means 42 is an aperture 44.

It is presently preferred that such shopping cart including such security device 20 is nestable with at least one additional shopping cart.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A security device for attachment to a shopping cart, said security device comprising:
a. a generally hollow cage member manufactured from a predetermined material and having a predetermined size and a predetermined shape for enclosing at least one predetermined item therein;
b. a first access means engaged with said cage member for enabling a user to selectively access an interior portion of said cage member; and
c. a securing means disposed on said cage member and engageable with such shopping cart for releasably attaching said cage member to such shopping cart at a predetermined location at least one of on such shopping cart, within such shopping cart, and a combination thereof.

2. A security device according to claim 1 wherein said cage member is collapsible.

3. A security device according to claim 1 wherein said security device is at least one of stackable, nestable, and a combination thereof, with at least one of at least one additional security device, at least one shopping cart, and a combination thereof.

4. A security device according to claim 1 wherein said predetermined material is at least one of metal, plastic, and a combination thereof.

5. A security device according to claim 4 wherein said predetermined material is metal.

6. A security device according to claim 1 wherein said securing means is at least one of at least one hook, at least one clamp, at least one clasp, and a combination thereof.

7. A security device according to claim 6 wherein said securing means is at least one hook.

8. A security device according to claim 1 wherein said first access means is a door member hingedly connected to said cage member.

9. A security device according to claim 8 wherein said door member is formed from a predetermined arrangement of a plurality of inter-connected bar members extending at least one of laterally, longitudinally, and a combination thereof.

10. A security device according to claim 8 wherein said security device further includes a lock member engageable with said cage member and said door member for selectively locking said door member in a closed position.

11. A security device according to claim 8 wherein said security device further includes a second access means disposed on at least one of said cage member and said door member for enabling a user to access said interior portion of said cage member.

12. A security device according to claim 11 wherein said second access means is an aperture.

13. A security device according to claim 1 wherein said cage member includes a bottom, two pairs of opposed walls collapsibly connected to said bottom and extending upwardly there from to provide an open top, and wherein said bottom and said walls further include a predetermined arrangement of at least one of a plurality of vertical bars, a plurality of horizontal bars, and a combination thereof.

14. In combination with a shopping cart, the improvement comprising a security device attached thereto, said security device including:
a. a generally hollow cage member manufactured from a predetermined material and having a predetermined size and a predetermined shape for enclosing at least one predetermined item therein; and
b. an access means engaged with said cage member for enabling a user to selectively access an interior portion of said cage member.

15. The device according to claim 14 wherein said cage member is collapsible.

16. The device according to claim 14 wherein said shopping cart including said security device is nestable with at least one additional shopping cart.

17. A security device according to claim 14 wherein said predetermined material is at least one of metal, plastic, and a combination thereof.

18. A security device according to claim 14 wherein said access means is a door member hingedly connected to said cage member.

19. A security device according to claim 18 wherein said security device further includes a second access means disposed on at least one of said cage member and said door member for enabling a user to access said interior portion of said cage member.

20. A security device according to claim 19 wherein said second access means is an aperture.
